(19) United States
(12) Patent Application Publication
(10) Pub. No.: US 2022/0060332 A1
(43) Pub. Date: Feb. 24, 2022

(54) ENERGIZED IDENTITY POWERED BLOCKCHAIN

(71) Applicant: Commonwealth Scientific and Industrial Research Organisation, Acton (AU)

(72) Inventors: Dongxi LIU, Acton (AU); Shiping CHEN, Acton (AU)

(73) Assignee: Commonwealth Scientific and Industrial Research Organisation, Acton (AU)

(21) Appl. No.: 17/414,869

(22) PCT Filed: Feb. 21, 2020
(86) PCT No.: PCT/AU2020/050150

§ 371 Date: Jun. 16, 2021

(30) Foreign Application Priority Data
Feb. 12, 2019 (AU) 2019900586

(51) Int. Cl. H04L 9/32; H04L 9/00

(52) U.S. Cl. CPC H04L 9/3218; H04L 2209/38; H04L 9/006; H04L 9/3236

(57) ABSTRACT

A method (100) for block generation in a distributed ledger is presented. Each client device of a plurality of client devices (302) to (308) defines an associated battery (200). Each battery (200) comprises a proof-of-work (PoW) (202) and a unique identifier (204) of the associated client device. Each of the plurality of client devices (302) to (308) broadcasts the associated battery (200) to a plurality of nodes that maintain the distributed ledger. The plurality of nodes record the battery in the distributed ledger and select, via a battery selection algorithm, a first battery associated with a first client device to generate a new block in the distributed ledger. The first client device generates the new block using the first battery.

### CROSS-REFERENCE TO RELATED APPLICATIONS

The present application claims priority from Australian Provisional Patent Application No 2019900586 filed on 21 Feb. 2019, the contents of which are incorporated herein by reference in their entirety.

### TECHNICAL FIELD

This disclosure relates to distributed ledger technology and in particular, but not limited to, blockchain databases employing proof-of-work (PoW) methods.

### BACKGROUND

Any discussion of the prior art throughout the specification should in no way be considered as an admission that such prior art is widely known or forms part if the common general knowledge in the field.

A blockchain is an open distributed ledger which is resistant to modification. The blockchain comprises a list of records stored in ‘blocks’ which are cryptographically linked. Every block added to the blockchain contains a cryptographic hash of the previous block.

Blockchain has potential applications in many areas, such as supply chain integrity. There are two main methods for supporting the integrity of data in blocks on the blockchain. These are proof-of-work (PoW) and proof-of-stake (PoS).

In a PoW blockchain, ‘miners’, typically using specialised hardware, are involved in a competition to search for pseudo-random numbers. Only one miner can win this competition by finding such a random number. The number is then used to create the hash value of a new block. This system effectively only allows one miner to produce or mine the next new block in the blockchain. Even if several miners find suitable numbers, only one of them can win. Currently, miners with ordinary computing power (e.g., a Laptop or a smartphone) have negligible chance of winning the competition.

Traditional PoW methodologies have low throughput. For example, Bitcoin can normally maintain around 1-2 transactions per second (TPS) throughput and Ethereum can averagely reach around 15 TPS.

Typically, the more miners that compete in the search for the pseudo-random number, the more difficult the competition is and in turn the more energy is consumed by each miner.

In a PoS blockchain, a new block is determined by participants with a probability proportional to their stake in the blockchain. Thus, the integrity of the blockchain might be controlled by a small number of participants who each have a large stake in the blockchain. The people with small stakes or no stakes can make little or no contribution to the blockchain.

Construction of a PoW based blockchain consumes significantly more energy than a PoS based blockchain but is significantly more robust because it cannot be built without expenditure of significant amounts of energy.

### SUMMARY

There is provided a method for block generation in a distributed ledger, the method comprising:

each client device of a plurality of client devices defining an associated battery, wherein each battery comprises a proof-of-work (PoW) and a unique identifier of the associated client device;

each client device of the plurality of client devices broadcasting the associated battery to a plurality of nodes that maintain the distributed ledger;

the plurality of nodes recording the battery in the distributed ledger;

the plurality of nodes selecting, via a battery selection algorithm, a first battery associated with a first client of the plurality of client devices to generate a new block in the distributed ledger; and

the first client device generating the new block using the first battery.

It is an advantage of this method that energy expended by a client device for performing a proof-of-work is not wasted and is used as part of a battery to generate a new block in a blockchain.

The unique identifier may further comprises a unique battery identifier of the battery.

It is an advantage of this method that a client device may have more than one battery.

The unique identifier may comprise a public encryption key of the associated client device.

It is an advantage of this method that nodes in the network are able to verify a client's signature using the client's unique identifier.

The PoW may be based on an existing block.

The PoW may comprise receiving as an input:
(hash(b) XOR blind)

where ‘hash(b)’ is a hash of the existing block b on which the PoW was performed, and ‘blind’ is a random value.

It is an advantage of this method that the contents of block b can be hidden from miners.

The battery selection algorithm may comprise assigning a greater probability of selection to one or more battery recorded on the oldest block of the distributed ledger.

It is an advantage of this method that older batteries are utilised at a greater rate, thereby reducing the likelihood of a battery existing on the blockchain for an extended period of time.

The battery selection algorithm may further comprise assigning a greater probability of selection to one or more batteries recorded in the oldest generated block that themselves are based on the youngest generated block.

There is provided a network for maintaining a distributed ledger, the system comprising a plurality of nodes and a plurality of client devices,

wherein each of the plurality of client devices is configured to:

define an associated battery, wherein each battery comprises a proof of work (PoW)

and a unique identifier of the associated client device;

broadcast the battery to the plurality of nodes over the network; and

generate a new block in response to being selected by the nodes;

and each of the plurality of nodes is configured to:

receive batteries broadcast over the network;

record the received batteries in the distributed ledger; and

select, via a battery selection algorithm, a first battery associated with a first client of the plurality of client devices to generate a new block in the distributed ledger.

There is provided a method performed by a client device for generating a block in a distributed ledger, the method comprising:

defining a battery, wherein the battery comprises a proof of work (PoW) and a unique identifier of the associated device;

broadcasting the battery over a network to a plurality of nodes; and

generating a new block in response to the battery being selected by the plurality of nodes wherein the nodes select the battery from a plurality of broadcast batteries via a battery selection algorithm.

There is provided a device for block generation in a distributed ledger, the device comprising a processor configured to:

define a battery, wherein the battery comprises a proof of work (PoW) and a unique identifier of the associated device;

broadcast the battery over a network to a plurality of nodes; and

generate a new block in response to the battery being selected by the plurality of nodes wherein the nodes select the battery from a plurality of broadcast batteries via a battery selection algorithm.

There is provided an (optionally non-transitory) computer readable medium configured to store instructions that when executed cause a processor to perform:

defining a battery, wherein the battery comprises a proof of work (PoW) and a unique identifier of the associated device;

broadcasting the battery over a network to a plurality of nodes; and

generating a new block in response to the battery being selected by the plurality of nodes wherein the nodes select the battery from a plurality of broadcast batteries via a battery selection algorithm.

There is provided a method performed by a node for maintaining a distributed ledger, the method comprising:

receiving a plurality of batteries over a network from a plurality of client devices, wherein each battery comprises a proof of work (PoW) and a unique identifier of the associated client device;

recording the received batteries in the distributed ledger; and

selecting, via a battery selection algorithm, a first battery associated with a first client of the plurality of client devices of the network to generate a new block in the distributed ledger.

There is provided a device for maintaining a distributed ledger, the device comprising a processor configured to:

receive a plurality of batteries over a network from a plurality of client devices, wherein each battery comprises a proof of work (PoW) and a unique identifier of the associated client device;

record the received batteries in the distributed ledger; and

select, via a battery selection algorithm, a first battery associated with a first client of the plurality of client devices of the network to generate a new block in the distributed ledger.

There is provided an (optionally non-transitory) computer readable medium configured to store instructions that when executed cause a processor to perform:

receiving a plurality of batteries over a network from a plurality of client devices, wherein each battery comprises a proof of work (PoW) and a unique identifier of the associated client device;

recording the received batteries in the distributed ledger; and

selecting, via a battery selection algorithm, a first battery associated with a first client of the plurality of client devices of the network to generate a new block in the distributed ledger.

### BRIEF DESCRIPTION OF DRAWINGS

A preferred embodiment of the invention will now be described, by way of example only, with reference to the accompanying drawings in which:

FIG. 1 illustrates an exemplary method according to one embodiment;

FIG. 2 is a schematic illustration of a battery according to one embodiment;

FIG. 3 is a schematic illustration of a distributed network;

FIG. 4 is a schematic illustration of a battery according to one embodiment;

FIG. 5 is a schematic illustration of a block structure according to one embodiment;

FIG. 6 is a schematic illustration of a block structure according to one embodiment;

FIG. 7 is a schematic illustration of a first network;

FIG. 8 is a schematic illustration of a first network;

FIG. 9 is a schematic illustration of an exemplary buffer structure;

FIG. 10 is a schematic illustration of an algorithm for selecting a battery; and

FIG. 11 is a schematic illustration of an algorithm for selecting candidate batteries.

### DESCRIPTION OF EMBODIMENTS

The disclosure relates to proof-of-work (PoW) methodologies. In particular, the disclosure relates to non-competitive PoW methodologies for use in distributed ledger technologies, also referred to as EnerID blockchain, and supports both real time and non-real time data recording in blockchains.

PoW is a foundational mechanism to support the integrity of blockchains, such as BitCoin blockchain (see details in S. Nakamoto; Bitcoin: A peer-to-peer electronic cash system. URL: http://bitcoin.org/bitcoin.pdf) and FruitChains (see details in R. Pass and E. Shi; FruitChains: A Fair Blockchain; proceedings of the ACM Symposium on Principles of Distributed Computing (PODC '17), 2017). The commonly-used PoW mechanism is based on cryptographic hash functions. Given a blockchain-specific information info, the hash-based PoW requires users searching for a random number, or nonce, such that the output of the hash function, hash(nonce, info), satisfies the criteria like smaller than particular values specified by PoW-based blockchain protocols. Due to the one-way and pseudo-random feature of hash functions, the number nonce can only be obtained by searching in a trial-and-error manner. Thus, a proper nonce is used as a PoW. NIST has standardized a number of hash algorithms, such as SHA-256, which is used in BitCoin blockchain. Not only the hash-based PoW mechanisms, the EnerID blockchain in this disclosure can be implemented with any PoW mechanisms. The main criteria that a PoW mechanism must satisfy is that the solution (i.e., nonce in this disclosure) must be costly and/or time consuming to produce, but easily verified. Due to this un-deterministic and time consuming nature of PoW, the current PoW-based blockchains cannot record data in a real time manner.

A PoW based blockchain consumes a significant amount of energy to construct. However, it is this energy consumption which provides the robustness of the method and is in effect by design. Any attempt to recreate/re-write the blockchain would require at least the same amount of energy to be spent again, as it will be necessary to re-mine all of the random numbers.

However, over and above the energy consumed by the winning miner, a significant amount of energy is essentially wasted by the many losing miners. These losing miners also consumed energy searching for random numbers, but since they did not win the competition they do not have the ability to sign a new block in the blockchain. Accordingly, the energy spent by these losing miners is wasted and hence the energy cost to construct the blockchain is significantly higher than what is apparent from the recorded PoW.

### Battery Based Proof-of-Work—Overview

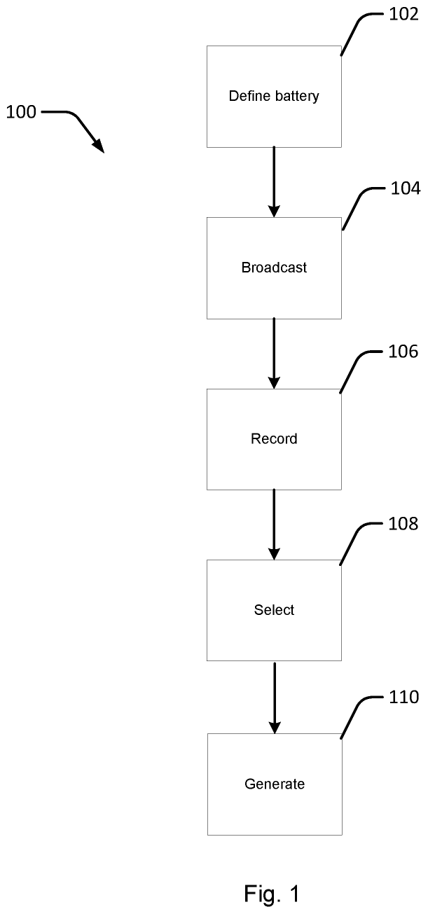

A more energy efficient PoW based distributed ledger is described with reference to FIG. 1 to FIG. 3.

A method 100 for block generation in a distributed ledger is illustrated in FIG. 1. Method 100 is performed in a distributed network 300, such as that shown in FIG. 3, comprising a plurality of client devices 302 to 306 and nodes 304 to 308.

It will be apparent from network 300 that some client devices 304, 306 are also nodes. Network 300 as illustrated is an exemplary network and should not be considered a limitation. Other configurations of network 300 include all client devices being nodes and all nodes being client devices as well as nodes and client device being mutually exclusive.

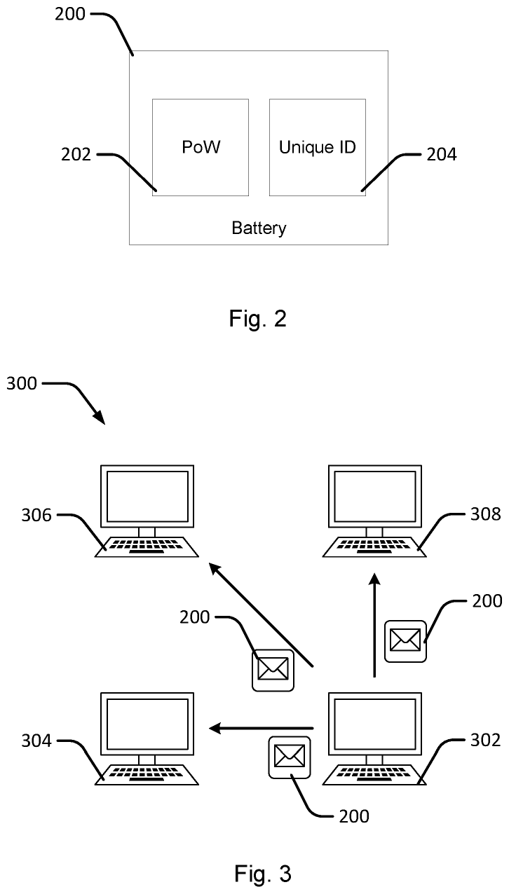

Method 100 begins at step 102 with each of a plurality of client devices 302 to 306 defining an associated battery 200, illustrated in FIG. 2. Each battery 200 comprises a proof-of-work 202 performed by the associated client device, and also a unique identifier 204 associated with that client device.

Once a battery 200 is defined at step 102, the battery 200 of each client device is then broadcast to a plurality of nodes that maintain the distributed ledger at step 104. For clarity, FIG. 3 only illustrates client device 302 broadcasting battery 200, however in practice this will be performed by each client device which defined a battery. Furthermore, the nodes and devices network 300 are in two-way communication with

At step 106, the plurality of nodes 304 to 308 record the received batteries in the distributed ledger. At a later time, nodes 304 to 308 perform step 108 wherein a battery selection algorithm is used by each node 304, 306, 308 to select a first battery associated with a first client device.

Step 110 is then performed by the first client device, which generates a new block in the distributed ledger using the first battery. Specifically, the PoW 202 of the first battery is used to generate the block.

The above method allows for more energy efficient construction of a PoW based distributed ledger as the energy expended by the non-winning miners is not wasted but is rather stored to be used at a later date. At the same time, this approach retains the robustness of a PoW ledger.

A further advantage to method 100 is it allows for greater throughput of the blockchain in that it allows for a greater rate of block formation. This advantage is achieved as a result of the repository of batteries which is recorded on the blockchain. The batteries can be drawn on to create blocks on as the need for a block arises. By contrast, prior art methods for PoW require the PoW to be contemporaneous with the block generation which leads to significant delays in block generation and therefore reduced throughput.

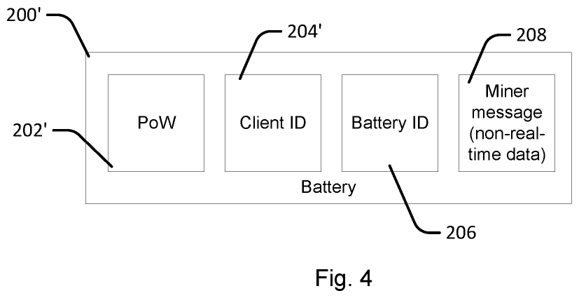

In some embodiments, as shown in FIG. 4, a battery 200′ further comprises a unique battery identifier 202′ of battery 200′. Battery identifier 206 defines a particular battery and allows a client device to produce multiple batteries with only a single client identifier. Battery 200′ may further include a miner message 208 which comprises data that the client device wishes to record in the blockchain. Due to the time required to generate the battery, discussed in more detail below, miner message 208 is suitable for non-real-time data recordal.

### Defining a Battery

To create a battery, a client device generates a public/private key pair (pk, sk), with the public key, pk, acting as unique identifier 204 for the client device. Any battery including unique identifier 204 of a client device is said to be associated with that client device. In the current example, the unique identifier is the public key generated by the client device. However, in other embodiments, unique identifier 204 may take different forms, including but not limited to, a unique serial number, an IP address, a unique media access control (MAC) address (whether universally or locally administered) or other appropriate identifier including combinations of identifiers.

Initially, the client has not performed a PoW and hence is not allowed to create blocks in the blockchain.

To formally define the PoW, let C denote a distributed ledger, b be a block with the block identifier blk-id in chain C. To perform the PoW, the client has to find a nonce or a random number, such that:
hash(pk, hash(b)⊕blind, nonce, battery-id, miner-message)<target,

where ⊕ is the exclusive-or operation (XOR), battery-id a new unique battery identifier, blind-a random value, miner-message as any message provided by the miner, and target is a parameter to control the degree of difficulty of the PoW. When C is a private chain, hash(b)⊕blind protects the secrecy of block b, while allowing the outsource of PoW and supporting a battery market without revealing the chain. In the PoW outsourcing scenario, miner-message can be replaced by its hash value to protect privacy. If C is public and the data in block b is not secret, then ⊕blind can be omitted from the PoW.

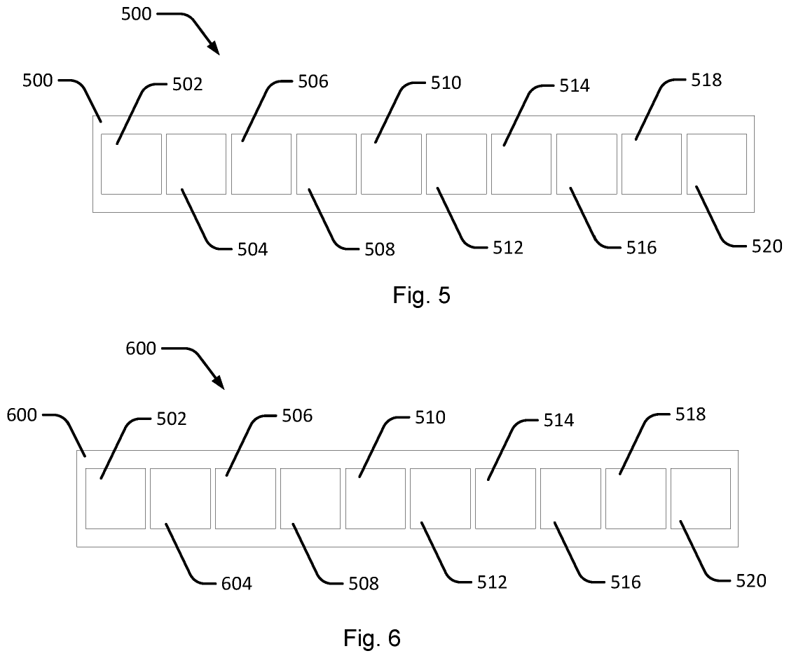

The battery can then be defined as:
(battery-id, nonce, blk-id, blind, pk, miner-message, sig)

where sig is the signature of the first four fields of the battery which can be verified with the public key pk. This battery is said to refer to the block ‘blk-id’ in C. Due to random nonce search, it takes time to generate a battery and hence miner-message 208 to be recorded in the battery is for non-real-time data recordal. Alternatively, data 518, discussed below with reference to FIG. 5, is for real time data, which is directly recorded in a block, since generating a new block does not involve PoW.

When a battery 200 is created, the client device 302 that defined 102 it broadcasts 104 it to the nodes in the network 300. In practice, battery 200 is a digital object or file including the information listed above, and is broadcast 104 by addressing battery 200 appropriately such that all possible nodes in network 300 receive it. In some embodiments, battery 200 is not broadcast to all possible nodes, but only to select nodes. In this embodiment, broadcast step 104 involves addressing battery 200 as a multicast digital object such that it is only transmitted to the intended nodes.

In some embodiments, client device 302 does perform broadcast step 104, but delegates broadcasting 104 battery 200 to another device.

Battery 200 is received by nodes 304 to 308 which verify PoW 202′. Assuming nodes 304 to 308 are able to verify PoW 202′, battery 200 is recorded 106 just as other data would be. That is, it is stored in a buffer (described in more detail below) to be added to a future block of chain C when the block is generated 110.

In most cases, nodes 304 to 308 select 108 the previously recorded batteries to generate the new block. Selection step 108 is described in detail below. As such, C stores not only data, but also a record of PoWs, in the form of batteries. This can be viewed as C storing energy to power its own growth. In some embodiments, C also stores some control instructions that control its growth. When creating a battery, best practice is that the client refers to the last block in the chain it can see.

### Battery Selection Algorithm Overview

As mentioned above, nodes 304 to 308 select 108 a battery to generate a new block. The battery selection algorithm selects batteries from those recorded in earlier blocks of C in a deterministic way. However, before the new block is added, probabilities are assigned to batteries for being selected to generate a block which will follow the new block. Higher probabilities are assigned to batteries recorded in earlier blocks of C. Among those batteries stored in early blocks, the batteries referring to more recent blocks are assigned a higher probability of selection. This provides incentives for client devices to refer to the most recent block when defining a battery. Details of an exemplary battery selection algorithm, termed ‘next(C)’, are provided in a separate section below.

During periods of increased data recording requests on C, such that block formation exceeds battery creation, the system is able to ‘draw down’ on the recorded batteries. In practice, the drawing down involves using the PoW 202′ stored in previously recorded batteries to perform the recording requests thereby using the stored batteries. That is, client devices which created the stored batteries are able to generate new blocks in C and thereby reduce the number of batteries stored in C (since batteries can only be used once). This provides an opportunity for all batteries to be consumed, including those from slow devices. Thus, the electricity used to produce batteries is not wasted; rather, it is stored in the batteries, waiting to be eventually consumed in blockchain construction.

In the method described above, each client has the opportunity to produce a battery regardless of computing power. This is because the client devices are not competing in real time to produce a PoW. Instead each client being able to independently produce a PoW in a time determined by their own available computing power. Hence, there is reduced incentive for pooling mining capability when compared to contemporaneous PoW methods. This is advantageous as pooling of miners is contrary to the important decentralized design goal of distributed ledgers.

### Block Structure

As described above, chain C is a series of linked blocks. Excluding the first, or genesis, block, a block b in C can be one of two types.

In the first type, illustrated schematically in FIG. 5, a block 500 comprises a unique block identifier 502, a battery identifier 504, a time stamp 506 indicating the time of creation of the block, an identifier of the previous block 508, a hash value of the previous block 510, a signature 512, a deterministic random number (DRN) 514, a control field 516, data 518 and batteries 520.

Battery identifier 504 is the unique identifier 204 of the battery 200 which was used to create the block 500. Battery identifier 504 is associated with a battery recorded on a previous block in C.

Signature 512 is a signature of all other fields 502 to 510 and 514 to 520 of block 500. Signature 512 can be verified with the public key pk associated with the battery identifier 504.

Data 518 includes the target data being stored on the distributed ledger and is a field containing the root of a Merkle hash tree.

Batteries 520 records newly generated batteries which can be used in future to create new blocks.

Control field 516 includes control instructions, such as the instructions scheduling a messaging server, and the instructions notifying the availability of a client device having an associated battery.

DRN 514 is deterministic to the client/battery creating this block, but random and unknown to other clients and nodes until this block is published. It is computed using the private key of the client that generated the block and the nonce and blind in the battery creating used by that client and the value of DRN 514 of previous block 508.

The second block type 600, illustrated schematically in FIG. 6, is similar to the first type 500 except that battery identifier 504 is replaced with battery 604. The block identifier in battery 604 must specify the last block in the chain, that is, battery 604 must refer to the last block in chain C. Note that battery 604 in this block has not been included in chain C. Second block type 600 allows for the further construction of chain C when clients selected to create a block are not responsive or when there are no batteries recorded in chain C.

### Blockchain Protocol

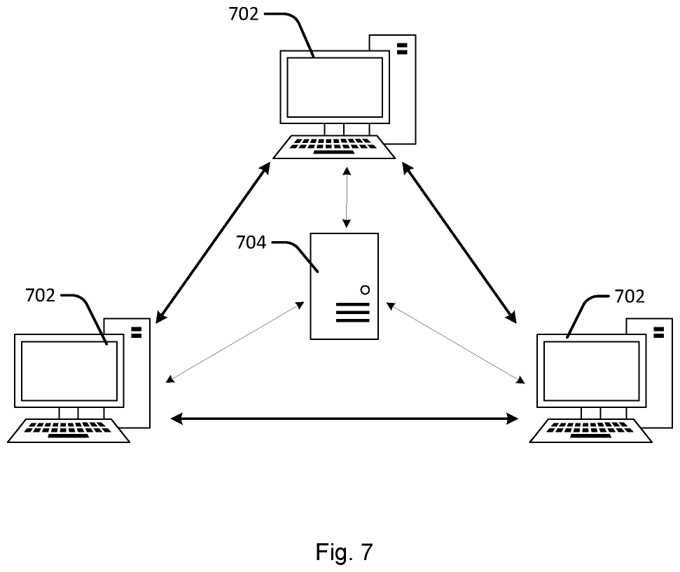

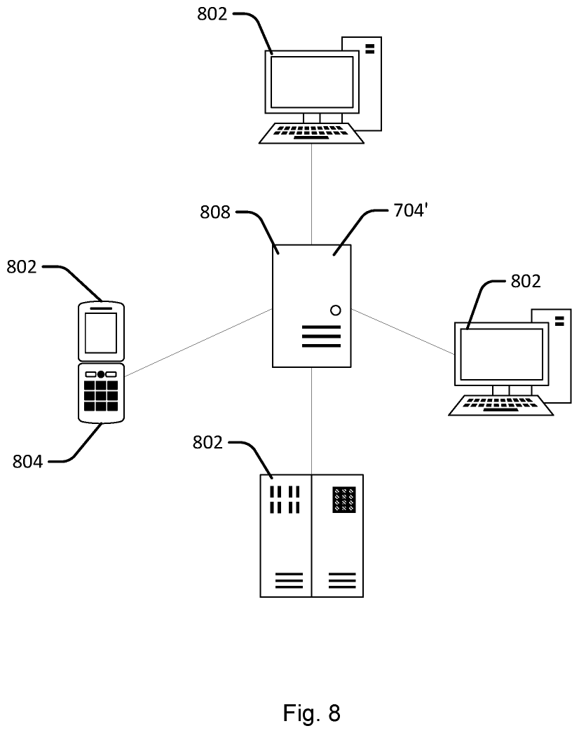

Two scenarios are contemplated, illustrated in FIG. 7 and FIG. 8 respectively. Network 700 of FIG. 7 is applicable to the first scenario, wherein all client devices 702 have public IP addresses and are always ready to create a new block or their unavailable time is predictable. A messaging server 704 is used to help new client devices or nodes connect into network 700. For enterprise blockchain applications, this scenario is suitable where nodes can be dedicated machines, which might come from different organisations, not trusted to each other, to maintain the blockchain. This is governed by a first blockchain protocol discussed in detail below.

In the second scenario of FIG. 8, the clients 802 are assumed to not be reliable. This may be because the client cannot be connected to nodes/clients due to lack of a public IP address or packet filtering by firewalls, or it may not always be connected to a network. For example, a client device 804 in this scenario may be a mobile phone which might be switched off or have a private IP address. This is governed by a second blockchain protocol discussed in detail below.

The first protocol is much simpler than the second one. These two protocols will be described below after introducing buffer structure.

### Genesis Block

In the first, or genesis, block, unique block identifier 502 is zero, battery identifier 504 is a public key of a message server, time stamp 506 indicates the time of creation of block 500, identifier of previous block 506 and hash of previous block 508 are both zero. Signature 512 is signature of time stamp 506 and control field 516 in this genesis block, DRN 514 is zero, data 518 and batteries 520 are both empty fields. Control field 516 includes instructions for selecting the next battery to create a new block in chain C, described in more detail below.

In the first scenario discussed above, a messaging server is used to help a client or node connect into the blockchain network. In the second scenario, it is used to facilitate network communication. The message server provides a public key, pk, to act as battery identifier 504 in the genesis block. Private key pk can verify signature 512. Public key pk is also used in battery identifier 504 in the second and third blocks, since there are no batteries included in the genesis block. The IP address of the messaging server and other information necessary for establishing communication channels can be included in control field 516.

### Buffer Structure

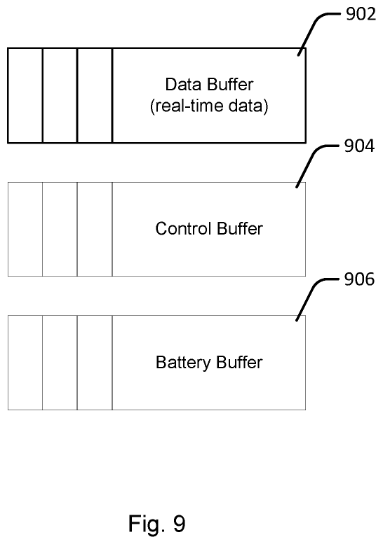

When a node or client submits data, batteries, or instruction to the blockchain, it is initially stored in three separate buffers of some or all of the nodes. The buffer structure is illustrated in FIG. 9 and comprises a data buffer 902, a control buffer 904 and a battery buffer 906 for respectively temporarily storing data, control information and batteries.

In some embodiments, the data in buffer 902 will be recorded without involving PoW; hence, it can be real-time data. The data in buffer 902 is signed by the client who submits the data and includes the corresponding public key of the client.

As no PoW is required for real-time data recordal, the client who submits the real-time data must provide remittance for the recordal to maintain Blockchain integrity. It may be, for example, that the client provides EnerID coins as remittance, where EnerID coins are units in a crypto-currency based on the EnerID blockchain. The client may purchase EnerID coins using other currencies, or, earn EnerID coin/s by using a mined battery to create a new block. The coins spent on real-time recording are consumed and are removed from the EnerID blockchain.

Depending on the block size, which is configured in control field 516, some of the data may be stored in the buffer 902 and some buffer contents will be recorded in the blockchain, when creating a new block. A client gets rewarded for signing a new block or suggesting batteries to be recorded in a new block being created by another client.

For the first blockchain protocol, each node has its own buffers. Note that only valid batteries are stored in battery buffer 906.

For the second blockchain protocol, applicable to networks such as network 800 of FIG. 8, buffers for the nodes are provided by messaging server 704′. This is because some of the clients/nodes are unreliable.

A buffer might be empty. Hence, a new block can record only data, only batteries, only control instructions, or their combinations.

In the first protocol, each node stores its own copy of the current blockchain, while in the second protocol, messaging server 704′ stores a copy and provides access to other nodes. This does not preclude the other nodes having buffers for distributed storage of the blockchain although it is not a requirement.

### First Blockchain Protocol

Given the current blockchain C, which is agreed by all nodes, a critical step of this protocol is to create the next block, which still can be agreed by all nodes. In this way, the protocol guarantees inductively the consensus of the growing chain among all nodes.

In this protocol, the next block is created by a battery. However, there is a requirement to select the battery deterministically, such that all nodes agree on the selected battery, and hence the next block created by it. In addition, if this battery is faulty creating several versions of new blocks even at different time, the protocol should have a deterministic mechanism to resolve the inconsistency.

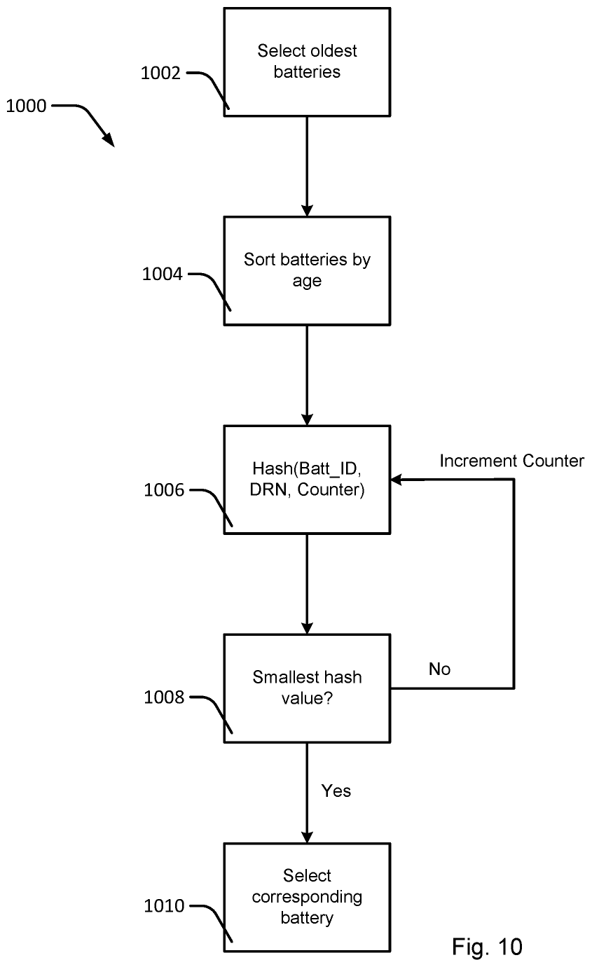

A battery selection algorithm represented by function ‘next(C)’ is illustrated in FIG. 10 and has been developed to select the next battery. This function is included in control field 516 of the genesis block.

In some embodiments, the next(C) function can be updated in later blocks.

A further function, reconciliation (C,C′), has also been developed to resolve inconsistency between two chains C and C′ by selecting a chain to keep. In the BitCoin protocol, the longer chain between C and C′ is kept. The reconciliation(C,C′) function considers more factors in making a decision and works even if C and C′ have the same length.

The next(C) and reconciliation(C,C′) functions are discussed in detail below.

For the first protocol, a battery can submit a signed instruction to the control buffer, indicating it will not be available to create new blocks; this statement becomes effective when it is included in a block. Similarly, when this identity becomes available again, it submits a signed statement, indicating its availability.

### Battery Selection Algorithm—Next(C) Function

As mentioned above, a battery recorded in C is selected 108 by the next(C) function from all the batteries stored in C. The next(C) function is a deterministic function shared by all client devices and nodes. As such, every client device can independently check whether a battery 200′ associated with it is selected; in which case, that client device generates 110 the next block in C. This block is then checked and agreed by nodes 304 to 308 in network 300, using the public key pk to verify the signature sig.

The next(C) function 1000 is illustrated in FIG. 10. Initially, at step 1002, the oldest available batteries recorded in C are selected. These batteries are then arranged in ascending order of age at step 1004. A hash value for each battery is then calculated at step 1006. The hash value is calculated using the battery identifier, DRN 514 and a counter value, such as a concatenation. At step 1008, the battery identifier which produced the smallest hash value is determined. The client device associated with this battery is then selected to produce the next block at step 1010. If two or more hash values are jointly smallest, then step 1006 is repeated after incrementing the counter value before repeating step 1008. Steps 1006 and 1008 are repeated with incrementing counter values until a battery is selected.

Hence, given the current chain C, each battery can independently check whether it is the selected battery using next(C) function 1000. The selected battery will then generate the next block to grow C. Since the generation of this new block does not involve contemporaneously performing PoW, it is generated quickly and the data recorded can be real time data. This new block is then broadcast to all other nodes directly by the client device associated with the selected battery or via the messaging server. The owner of a selected battery earns one EnerID coin if the new block is valid and included in the chain; the coin can be transacted with other clients or consumed by the owner itself with the private key corresponding to the public key in the selected battery.

The other nodes confirm whether the new block is signed by the battery calculated using next(C). If so, this new block is accepted unless the selected battery was the last usable battery in C. This can happen when a large number of requests are submitted to the blockchain in a short period of time exhausting the battery repository. To address this problem, if the last usable battery in C is returned by next(C), the new block signed by it must include at least one unused battery to be accepted. If there are no unused batteries to record, the client device associated with the selected battery has to wait until new batteries are mined before generating a new block using the selected battery.

When creating a new block, the selected client associated with the battery selected by next(C) records data from its local buffer; note that the data must be signed by a private key with enough coins as a validity condition. A new block is invalid if it includes invalid data. However, it only records batteries suggested by other client devices. This avoids a client device being able to only record batteries associated with itself or other set of preferred client devices.

This is achieved by the selected client, that is the client with the battery selected by next(C) 1000, issuing requests for suggestions of batteries to be included in the block. The requests are addressed to specific suggesting client devices identified using the procedure outlined below.

Let deterministic random number (DRN) and deterministic random number′ (DRN′) denote the values of DRN 514 field in this new block and the last block of C, respectively. Then, the i^{th} client which can suggest batteries is the client which creates the jth block in C satisfying:
j=(DRN⊕DRN′)ⁱ% len,

where len is the length of C (number of blocks), ⊕ is the XOR operator and % is the modulus operation. The i^{th} client can only suggest batteries with identifier battery_id, satisfying:
battery_id % N=i,

where N is the maximum number of batteries associated with other clients which can be suggested. This condition ensures a battery is not suggested by multiple suggesting clients.

Note that it is necessary for the selected client to make the request as the other clients do not know the value of DRN in the new block and hence cannot know if they are suitable for providing a suggestion.

The suggestions returned to the selected client from the i^{th} suggesting client are provided in the form:
(i, batteries, sig),

where sig is the signature, made with the private key of the i^{th} client, of the concatenation of i and the suggested batteries. This signature is verifiable with the public key of the suggesting client, which can be found through the battery-id in the jth block of C.

### Reconciliation(C,C′) Function

A battery that creates the last block of C might exhibit faulty behaviour by creating two versions of the new block, each recording different batteries and data hash values. To resolve this inconsistency, each node employs the reconciliation(C,C′) function to select which last block or which chain to keep.

In the first protocol, all batteries are available to create a block or their unavailability is predictable. In this eventuation, chain C can be extended using second block type 600 and the battery creating the block does not need to wait for the response of all battery-suggesting batteries. If this is allowed, there might be multiple new second type 600 blocks to extend C, when the selected battery does not respond. The following reconciliation function also needs to consider this case.

Given two blockchains C and C′, the function reconciliation(C,C′) is used by all nodes to determine which chain should be kept. The function is a two-step process.

If C and C′ are of different length, the longer one between C and C′ is kept.

Otherwise, the first block on which C and C′ do not agree is located; denoted b and b′ respectively. If only one of b and b′ is of the first type 500, then the chain containing it is retained as the trusted chain.

In the case where both b and b′ are of the first type 500, they must have been created by the same battery due to the definition of the next(C) function described above. In this case, the chain having smaller signature 512 value is retained as the trusted chain.

If both b and b′ are of the second block type 600, then the deterministic random number (DRN) 514 in the block preceding b and b′ is used in steps 1006 and 1008 of function 1000 to generate values for the batteries which created b and b′. The chain with the block created by the lower value is retained as the trusted chain. This avoids the situation where two separate chains grow and instead resolves the inconsistency based on existing data. By contrast, the BitCoin protocol allows both chains to grow and later selects the longer of the two.

Note that if all batteries recorded in C are not available, the protocol is equivalent to the traditional PoW blockchain used for BitCoin transactions.

Also note that when there are no available batteries, creating the second type 600 of new blocks will be much slower, hence affecting the throughput of the blockchain protocol. In this situation second protocol described below will yield higher throughput.

### Second Blockchain Protocol

In the second blockchain protocol, the availability of client devices is unpredictable and they might not have public IP addresses to directly receive notifications or requests from other miners. For example, client devices such as mobile phones may be switched off at certain times.

The unpredictable availability and private IP address problems are addressed with the assistance of messaging server 704′. The main messaging server 704′ is trusted to propagate messages, without segregating any network nodes. Note that the first protocol does not necessarily need a messaging server, while in this protocol it is a necessary part of the network architecture.

In the second protocol, management node 808 is designed as the main messaging server, via which a node can communicate with another node if they both do not have public IP addresses. Every available client device having a battery keeps a network connection with messaging server 704′. In addition to the main messaging server, other nodes can make a request to become scheduled messaging servers.

Management node 808 has a public/private key pair which update sporadically; its initial public key is recorded in the genesis block. Management node 808 can create new key pairs and include the new public key in control field 516 of a block propagated by it. When a new public key of management node 808 is published in a new block, the old public key is not valid any more. When management node 808 propagates new blocks, it appends a propagation signature to the control field. The propagation signature is a signature of the whole block.

A client having a battery can request to be a scheduled messaging server when creating a new block. After the request is approved by management node 808, the client device becomes the scheduled messaging server, which propagates new blocks with its signature added in control field 516 of new blocks. The requests and approvals for scheduled messaging servers are also recorded in control field 516. In the approval, the management node indicates 10 blocks (configurable) can be propagated by this scheduled message server. In the following three cases, management node 808 gets back the control of message propagation:
a. A scheduled messaging server has handled the planned number of blocks;
b. A scheduled messaging server fails to propagate messages within a predetermined time (10 secs configurable);
c. A scheduled messaging server is deemed dishonest, due to it propagating inconsistent new blocks to other nodes.

In the second protocol, an updated next(C) function is used to return a set of candidate batteries, instead of only one as in the first protocol. The size of the set is configurable. A bigger set allows more eligible batteries for creating new blocks, at the cost of increased network traffic and increased processing by messaging server 704′.

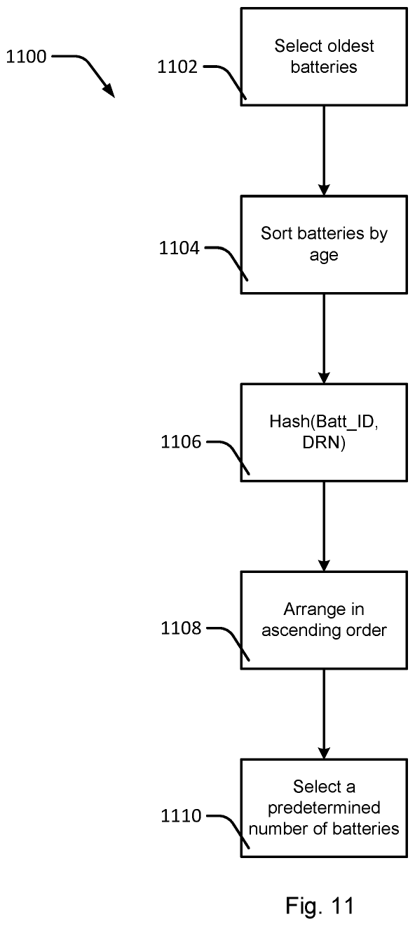

The updated next(C) function 1100 is similar to next(C) function NN and is described with reference to FIG. 11 below.

Initially, at step 1102, the 100 oldest available batteries recorded in C are selected. These batteries are then arranged in ascending order of age at step 1104. A hash value for each battery is then calculated at step 1106. The hash value is calculated using the concatenation of the battery identifier 402 and DRN 514 of the last block of C. At step 1108, the hash values are arranged in ascending order before. The batteries corresponding to the first few hash values are then selected at step 1110, with the exact number selected being a configurable parameter which will be application specific.

Note that the list of candidates returned by this updated next(C) function can be ordered with steps 1006 and 1008 of the original next(C) function 1000.

In the second blockchain protocol, the current chain C can be extended with two types of blocks:
Blocks of the first type 500 structure created by a battery selected with updated next(C) function 1100; or
Blocks of the second type 600 created by a newly mined battery that refers to the last block in C.

If at least one battery selected by updated next(C) function 1100 is available, the new block built by this battery is of first type 500. If all of the selected batteries are not available, a newly mined battery will be used to create a new block of the second type 600.

The message propagation time in the network is nominally set to 10 seconds (a configurable number). With the updated next(C) function 1100, the chain C is extended with a new block of either the first type 500 or second type 600.

A block of the first type is added if the client device associated with the battery selected by the updated next(C) function 1100 is available. In addition, if the client would like to act as a scheduled messaging server, it can indicate this request in control field 516 of the block by including its public IP address. The batteries and data field are constructed in the same way as in the first scenario; however, if all other clients or nodes, which are responsible for suggesting batteries, are not responding within a predetermined time period (nominally 10 seconds), the management node can provide a configurable number of batteries to the client.

This new block is then sent to the management node and also the current scheduled messaging server if there is one approved in the most recent block in C.

A block of the second type is generated if all client devices associated with batteries selected by updated next(C) are not available. Furthermore, this block cannot be added immediately. The management node 808 or the scheduled messaging server then waits for the mining of a new battery that refers to the last block in C. The client associated with the new battery then creates a new block of the second type 600 to grow C. This new block is then sent to the management node and the scheduled messaging server. The batteries of clients creating such new blocks are ordered with steps 1006 and 1008 of the original next(C) function 1000, and the new block, created by the smallest battery_id, is selected and propagated by the management node or the scheduled messaging server as they do above.

Note that it takes much more time to create the second type 600 of block, since contemporaneous proof of work is involved. This gives enough time for selected batteries to create and propagate the first type 500 of block if there are batteries available. The updated reconciliation function below deals with the case in which the first type block and the second type block circulate in the network at the same time.

In this case, new blocks from the eligible client devices are received by the management node or the scheduled messaging server which select one of them to extend the chain. They then propagate the selected block to the whole network, as described below.

When the management node or the scheduled messaging server gets the new blocks from the eligible client devices, they need to select one of them to extend the chain and propagate this new block to the whole network, as described below.

If there is no scheduled messaging server, the management node sorts the received new blocks at the end of 10 seconds according to battery identifier in these new blocks and selects a client using steps 1006 and 1008 of function 1000 Note that the management node can proceed immediately, without waiting 10 secs, if the candidate battery calculated by the original next(C) responds with a new block.

Then, the management node adds into control field 516 the approval to the latest scheduled server request, if there is one that has not been approved. The approval indicates the number blocks (a configurable number) this scheduled server can handle.

Finally, the management node signs the block, puts this signature (i.e., propagation signature) into control field 516, and propagates this block to all other nodes. This new block is accepted if the following conditions are satisfied:
the battery-id signing this block is within the range of next(C);
the propagation signature in the control field is also valid; and
the field of batteries is properly suggested by client devices as described in the first scenario or suggested by the management node.

If there is one approved scheduled server, this server handles the new blocks in the same way as the management node, except that it cannot approve requests. Then, the scheduled messaging server signs the block, puts the propagation signature into control field 516, and propagates this block to the management node and all identities that could subsequently be selected by updated next(C). The management node also forwards this new block to all nodes. Since the scheduled server might be a small device, this propagation strategy can reduce the processing burden of the scheduled server. This new block is checked in the same way for its acceptance.

At the end of 20 seconds (double of the network propagation time, configurable), if the scheduled messaging server has not propagated any new blocks and the management node knows some clients with selected batteries have provided new blocks, the management node will test the scheduled messaging server for responsiveness. If it does not respond, the management node creates the new block as described above. In addition, the management mode cancels the approval to the scheduled server since it is not responding.

When a node wants to provide blockchain storage service, it can make a request in the same way as requesting to be a scheduled server. The management node and the scheduled messaging servers propagate the new blocks to nodes approved for providing blockchain storage services.

When there are multiple blockchain storages, if one scheduled server propagates inconsistent blocks (i.e., propagating blocks created by different client devices), this inconsistency will be detected when its role as the scheduled message server is over. Another inconsistency can occur when the scheduled messaging server starts propagation after the management node has deemed it to not be available.

When inconsistency happens, the updated reconciliation function defined below will be used by all storage services and nodes to decide which chain should be kept.

### Updated Reconciliation Function

Given two chains, C and C′, the updated reconciliation(C,C′) function is used by all nodes to determine which chain should be retained. On input of C and C′, this function is defined with the steps below.

If C and C′ have different length, the longer one between C and C′ is kept.

Otherwise, the first block on which C and C′ do not agree is located; denoted b and b′ respectively. If one of b and b′ has the propagation signature from the scheduled messaging server and the other one has the propagation signature from the management node, then the chain containing the block propagated by the scheduled server is kept.

If only one of b and b′ is of the first type 500, then the chain containing it is kept.

If both b and b′ are of the second block type 600, then the DRN 514 in the block preceding b and b′ is used in steps 1006 and 1008 of function 1000 to generate values for the batteries which created b and b′. The chain with the block created by the lower value is retained as the trusted chain. This avoids the situation where two separate chains grow and instead resolves the inconsistency based on existing data. By contrast, the BitCoin protocol allows both chains to grow and later selects the longer of the two.

In the case where both b and b′ are of the first type 500 and have been created by the same battery but have different data hash values or batteries, then the chain having smaller signature 512 value in b or b′ is retained as the trusted chain.

If both b and b′ are second type 600 blocks, the process is the same as if they were both first type 500 blocks.

Note that updated reconciliation(C,C′) function is a deterministic function and all nodes agree on the outcome.

### Authority

In addition to batteries, the second protocol can support client devices with authority. In practice these may be devices belonging to a government agency, a class teacher, or the CEO of a company. A data recording request in the blockchain can indicate whether it will be recorded in a block created by an client with authority. When a client with authority creates a block, it collects only data specifying it as the block creator. For example, when students in a class submit homework, they may expect their homework in the same block created by their class teacher.

### Security

If malicious clients intend to tamper with a block in a chain and still want to keep the integrity of the chain, they have to re-construct the chain from the tampered block; otherwise, the signature in the subsequent blocks cannot be verified. For the second blockchain protocol, the propagation signature in control field 516 of the subsequent blocks cannot be verified either.

Security is provided by the fact that two inconsistent chains with the same genesis block cannot grow indefinitely. The basic idea of the blockchain security is that when inconsistent chains are being constructed by malicious clients, all honest clients can use the reconciliation function to disregard the corrupted chain. An assumption here is that malicious miners have less than a half of computing power in the network. That is, there are more honest clients to be selected to create new blocks. The honest clients will not contribute to a shorter chain that contains the block just tampered with by the malicious clients. These ideas are discussed in more detail below for each blockchain protocol.

### Security Features of First Blockchain Protocol

If it is assumed that at least half of the nodes and clients are honest then a chain C is robust to malicious activity. To illustrate this, suppose a block b in C has been accepted. If a malicious miner creates b, then it can tamper with b and re-sign the block b. Since we assume all nodes know all last blocks, only malicious clients with associated batteries can grow the tampered chain, which is short at the time of tampering. The original chain from block b grows with the blocks created by both honest and malicious clients with batteries. Since at least half of the clients used to construct new blocks from b in the original C are honest, the tampered chain remains short since its only contribution comes from malicious clients.

Moreover, if an honest client with a battery is selected by the next(C) function to create a new block in the tampered chain, then the tampered chain cannot be grown at all since the honest client will not grow a short chain. Since more honest clients build the chain, there is more chance that an honest client is selected by the next(C) function and the growth of the tampered chain eventually cannot continue. Note that the malicious clients can mine the second block type 600 to grow the tampered chain. However, PoW is slow and the reconciliation function gives preference to the longer chain and the first block type 500.

When the blockchain is deployed as a private chain among several mutually untrusted nodes (e.g., a blockchain among three mutually untrusted banks), the blockchain can provide stronger security without the above assumption. Suppose each client is associated with a node in a private chain. In this deployment, a node can guarantee the security of the data recorded between the genesis block and a block b, which is created by it. Even if all other nodes collude to tamper with a block between the genesis block and b, and manage to grow a longer chain without this node, this node can use these two inconsistent chains as evidence against the other nodes, since one client of a node must sign inconsistent blocks.

### Security Features of First Blockchain Protocol

For the second blockchain protocol, new blocks are regularly signed by the management node for propagation, with its signature included in control field 516. Assuming the management node always propagates all new blocks, it cannot be involved in propagating inconsistent blocks; otherwise, it will be caught because there are two new blocks with the same previous block, but with different propagation signatures from the management node.

Even if the management node propagates inconsistent blocks, only the malicious clients from the set returned by the updated next(C) function can be used to extend a tampered chain; otherwise, the re-constructed chain will get stuck as in the first protocol, since honest clients will not sign a block for a shorter chain. Since more batteries are from honest users, the tampered chain cannot grow as long as the chain constructed by honest clients.

### Economic Model

The first blockchain protocol is supposed to be deployed for enterprise blockchain applications, such that all miners/clients are dedicated machines and always available. For the second blockchain protocol, the management node can charge data recording and then pay to clients with batteries who create new blocks and/or suggest batteries for new blocks. Due to this economic incentive, the management node can be deployed in a data centre, providing efficient and reliable messaging services, and would not propagate inconsistent blocks. Note that propagation of inconsistent blocks does not affect security of the blockchain, as discussed above. However, it will affect efficiency, because nodes need to transfer chains and do reconciliation.

In the blockchain protocols, client devices with associated batteries and messaging servers are held accountable since their signatures are included in new blocks created or propagated. When the next(C) function selects a battery, the public key of the client associated with that battery can be required to own a predetermined number of usable batteries. If this client creates inconsistent new blocks, as a penalty, its usable batteries will no longer be considered by the next(C) function. In a similar way, the scheduled messaging server can be approved by the management node.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for block generation in a distributed ledger, the method comprising:
each client device of a plurality of client devices defining an associated battery, wherein each battery comprises a proof-of-work (PoW) and a unique identifier of the associated client device;
each client device of the plurality of client devices broadcasting the associated battery to a plurality of nodes that maintain the distributed ledger;
the plurality of nodes recording the battery in the distributed ledger;
the plurality of nodes selecting, via a battery selection algorithm, a first battery associated with a first client of the plurality of client devices to generate a new block in the distributed ledger; and
the first client device generating the new block using the first battery.

2. The method of claim 1 wherein the unique identifier further comprises a unique battery identifier of the battery.

3. The method of claim 1, wherein the unique identifier comprises a public encryption key of the associated client device.

4. The method of claim 1, wherein PoW is based on an existing block.

5. The method of claim 4 wherein the PoW comprises receiving as an input
(hash(b) XOR blind)
where ‘hash(b)’ is a hash of the existing block b on which the PoW was performed, and ‘blind’ is a random value.

6. The method of claim 1, wherein the battery selection algorithm comprises assigning a greater probability of selection to one or more battery recorded on the oldest block of the distributed ledger.

7. The method of claim 6 wherein the battery selection algorithm further comprises assigning a greater probability of selection to one or more batteries recorded in the oldest generated block that themselves are based on the youngest generated block.

8. A network for maintaining a distributed ledger, the system comprising a plurality of nodes and a plurality of client devices,
wherein each of the plurality of client devices is configured to:
define an associated battery, wherein each battery comprises a proof of work (PoW) and a unique identifier of the associated client device;
broadcast the battery to the plurality of nodes over the network; and
generate a new block in response to being selected by the nodes;
and each of the plurality of nodes is configured to:
receive batteries broadcast over the network;
record the received batteries in the distributed ledger; and
select, via a battery selection algorithm, a first battery associated with a first client of the plurality of client devices to generate a new block in the distributed ledger.

9. A method performed by a client device for generating a block in a distributed ledger, the method comprising:
defining a battery, wherein the battery comprises a proof of work (PoW) and a unique identifier of the associated device;
broadcasting the battery over a network to a plurality of nodes; and
generating a new block in response to the battery being selected by the plurality of nodes wherein the nodes select the battery from a plurality of broadcast batteries via a battery selection algorithm.

10.-14. (canceled)
